(19) United States
(12) Patent Application Publication
(10) Pub. No.: US 2008/0216289 A1
(43) Pub. Date: Sep. 11, 2008

(54) Lifting Device for a Two-Leaf Folding Door

(76) Inventor: Luciano Salice, Carimate (IT)

Correspondence Address: Dilworth&Barrese, 333 Eaele Ovington Blvd, Suite 702, Uniondale, NY, 11553, US

(21) Appl. No.: 11/662,030

(22) PCT Filed: May 5, 2006
(86) PCT No.: PCT/EP2006/004235

§ 371 Date: Mar. 17, 2008

(30) Foreign Application Priority Data
Jul. 18, 2005 (DE) 202005011283.6
Oct. 19, 2005 (DE) 202005016405.4

(51) Int. Cl. E05D 3/06; E05D 15/52

(52) U.S. Cl. 16/366; 49/192

(57) ABSTRACT

A lifting device for a two-leaf folding door is provided, whose upper leaf is pivotally mounted about a horizontal first axis on a top or intermediate wall of a body, and whose lower leaf is pivotally connected with the upper leaf about a second axis parallel to the first axis, and having at least one two-armed lever which is pivotally mounted about a horizontal swivel axis on a lateral body part and whose longer arm is pivotally connected with the lower leaf, a hinge for pivotally connecting the two leaves, which is provided with a hinge pot to be inserted in one of the leaves, a hinge arm to be fixed at the other leaf, and a swivel axis which is arranged in the hinge pot such that its distance (A) from the nearest edge of the other leaf reduced by the distance (T) from the inner surface of its own leaf, has a value (F) which is smaller than the thickness of the finger of a user, and in the closed condition of the folding door, the swivel axes of the lever of the lifting device are arranged such that together with the swivel axis between the two leaves and the swivel axis of a hinge connecting the upper leaf with the upper body wall, they form a four-link system, whose opposite legs extend approximately parallel to each other and whose lengths do not differ from each other by more than 20%.

This invention relates to a lifting device for a two-leaf folding door as claimed in the generic part of claim 1.

From DE 201 00 662 U, a lifting device for a two-leaf folding door is known, whose upper leaf is pivotally mounted about a horizontal first axis on a top or intermediate wall of a cupboard, and whose lower leaf is pivotally connected with the upper leaf about a second axis parallel to the first axis. The lifting device consists of at least one double-armed lever which is pivotally mounted about a horizontal swivel axis on a lateral body part and whose longer arm is pivotally connected with the lower leaf. Furthermore, a compression spring element is provided, one end of which is pivotally connected with the body part and the other end of which is pivotally connected with the shorter lever arm.

The known folding door is opened in that a person grasps a non-illustrated, but necessary handle connected with the lower leaf, which must have a certain distance from the bottom edge of the lower leaf.

There is a demand to create lifting devices of the type mentioned above, which type provides for opening the folding door by simply pulling at the bottom edge of the lower leaf, without a handle having to be provided for this purpose.

From DE 20 2005 000 423 01 a device for a folding door is known, in which the hinge for connecting two partial flaps is provided with a stop which prevents that with the folding door closed the two partial flaps can be folded towards the furniture body at the point where they are connected with each other. Although not described there in this form, this arrangement facilitates opening the folding door and makes it superfluous to provide a handle. When the folding door is moved, however, a gap is created between the two folding parts, in which gap the user can get with his fingers and therefore can become injured by correspondingly pinching his finger.

From DE 103 35 709 A and DE 20 2005 000 814 A, hinges for pivotally connecting two partial flaps of a folding door are known, which are designed such that when closing the folding door, the pinching of fingers between the partial flaps can safely be prevented.

The object of the present invention now consists in creating a safe lifting device for folding doors, in which an injury of the user can safely be avoided without using special components or safety devices. Proceeding from a lifting device of the generic type with the features of the generic part of claim 1, this object is solved by combination with the features of the characterizing part.

Accordingly, there is provided a lifting device for a two-leaf folding door, whose upper leaf is pivotally mounted about a horizontal first axis on a top or intermediate wall of a furniture body, and whose lower leaf is pivotally connected with the upper leaf about a second axis parallel to the first axis. The lifting device consists of at least one two-armed lever, which is pivotally mounted about a horizontal swivel axis on a lateral body part of the cupboard and whose longer arm is pivotally connected with the lower leaf. In accordance with the invention, a hinge for pivotally connecting the two leaves, which is provided with a hinge pot to be inserted in one of the leaves and a hinge arm to be fixed at the other leaf, has a swivel axis which is arranged in the hinge pot such that its distance from the nearest edge of the other leaf reduced by the distance from the inner surface of its own leaf has a value which is smaller than the thickness of the finger of a user, in the closed condition of the folding door, the swivel axes of the lever of the lifting device therefore are arranged such that together with the swivel axis between the two leaves and the swivel axis of a hinge connecting the upper leaf with the upper body wall the same form a four-link system whose opposite legs extend approximately parallel to each other and whose lengths do not differ by more than 20%.

Particularly advantageous aspects of the invention can be taken from the sub-claims following the main claim.

Accordingly, the hinge pot preferably is inserted in the lower leaf.

Preferably, the hinge arm can selectively be adjustable in the three coordinate directions.

The legs of the four-link system between the swivel axis of the hinge connecting the upper leaf with the upper furniture wall and the upper swivel axis of the lever preferably can be 20% longer than the leg between the swivel axis between the two leaves and the lower swivel axis of the lever.

Furthermore, the leg of the four-link system between the upper swivel axis of the lever and the lower swivel axis can be 15% shorter than the leg between the swivel axis between the two leaves of the lever and the swivel axis of the hinge connecting the upper leaf with the upper furniture wall.

In the vicinity of its articulation at the lower leaf, the lever can acted upon by an eccentric friction device such that the swivelling speed of the door is changed or the lifting device can take any intermediate position.

Preferably, one end of a compression spring element is pivotally connected with the body part, whereas the other end is pivotally connected with the two-armed lever.

The compression spring element advantageously can be a gas spring.

Further details and advantages of the invention will be explained in detail with reference to an embodiment illustrated in the drawing, in which:

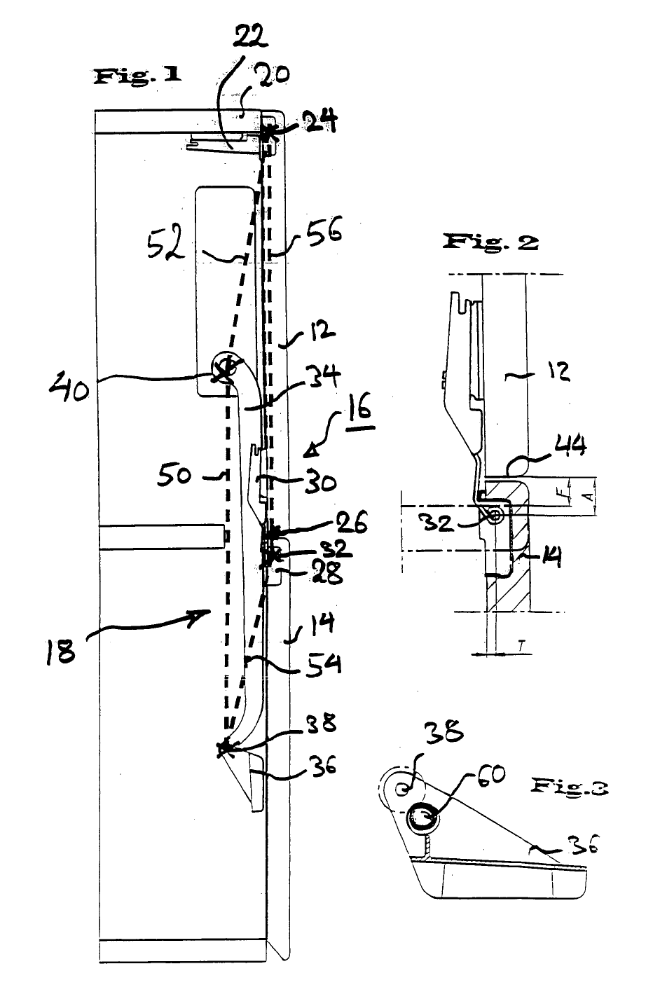

FIG. 1: shows a side view of the embodiment of the lifting device of the invention in the closed position of the folding door connected therewith,

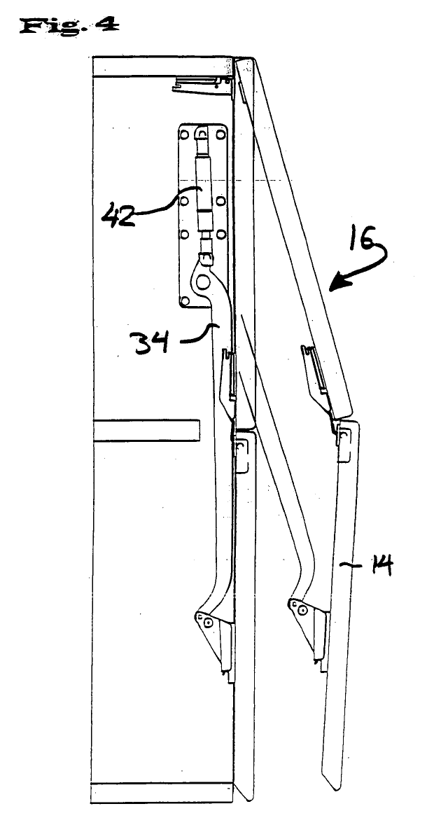

FIG. 2: shows a detail of the representation of FIG. 1 for illustrating the geometric proportions,

FIG. 3: shows a further detail of the representation of FIG. 1, in which an eccentric friction device is shown in the lower portion of the articulation of the lever,

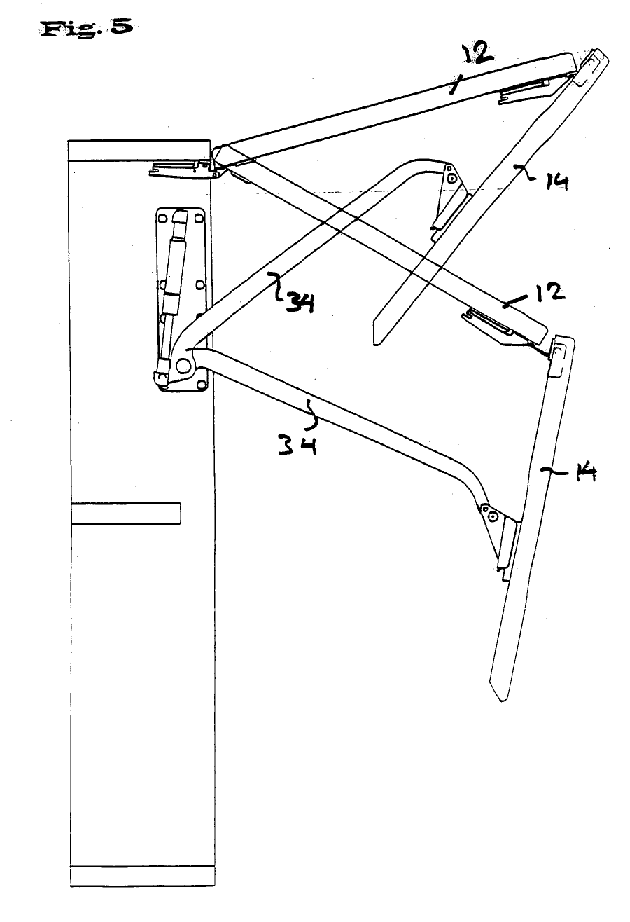

FIG. 4: shows a representation of the lifting device corresponding to FIG. 1, in which the folding door is shown on the one hand in a closed position and on the other hand in a slightly open position,

FIG. 5: shows a representation of the lifting device corresponding to FIG. 1, in which the folding door is in an intermediate open position and in a completely open position, and

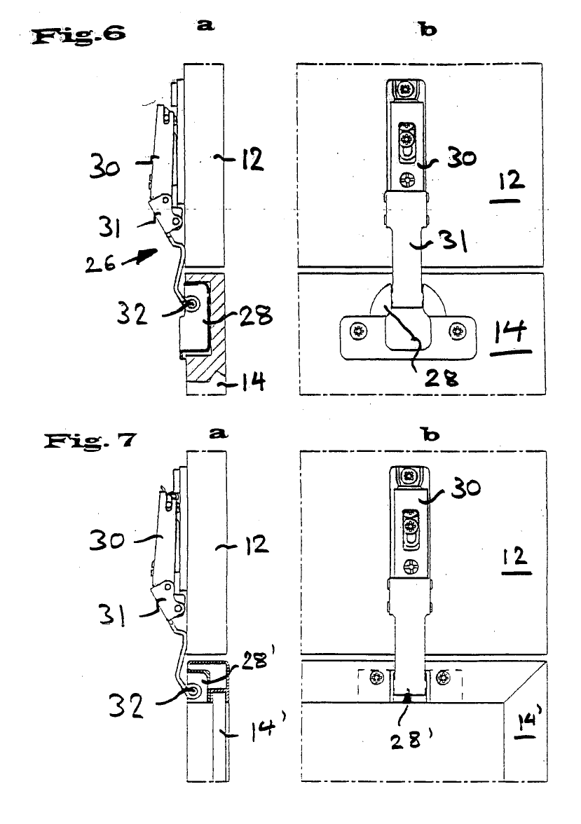

FIGS. 6a,b-11a,b: each show a partly sectional side view and a top view of different types of hinge, which connect the upper leaf and the lower leaf of a folding door with each other.

FIG. 1 shows a side view of the body, i.e. a cupboard or a cupboard or chest element, whose opening is closed by a folding door 16 consisting of two pivotally connected leaves 12, 14. The front side wall is removed in this representation, in order to reveal the lifting device 18 for the folding door. On the top wall 20 of the body, the upper leaf 12 of the folding door 16 is pivotally mounted in the usual way by means of two bidirectional hinges 22, so that said folding door can be swivelled about a swivel axis 24 defined by the hinges 22.

Via a further hinge 26, a lower leaf 14 is pivotally connected with the upper leaf 12. In the lower leaf 14, a hinge pot 28 of the joint 26 is inserted. On the other hand, the hinge arm 30 of the joint 26 is attached to the upper leaf 12. The joint 26 defines a swivel axis 32, about which the two leaves 12 and 14 of the folding door can be swivelled against each other.

In the manner known already from DE 201 00 662 U, the lifting device 18 has a two-armed lever 34, which is shown in FIG. 1 in a simplified way. The lever 34 forms a pivot point 38 with a fitting 36, which is connected with the lower leaf 14. The pivot point 38 likewise forms a horizontal swivel axis, which for simplification also is designated with 38. A further swivel axis 40 is formed by the upper pivot point of the lever 34.

The complete function of the two-armed lever arm 34 can be taken for instance from FIG. 4, which also shows the shorter lever arm of the two-armed lever 34. This shorter lever of the lever arm 34 is engaged by a gas spring 42, which in turn is pivotally mounted at the body with its free end.

In the enlarged representation of FIG. 2, the first feature of the characterizing part of claim 1 is explained. Here, the distance A between the swivel axis 32 and the nearest edge 44 of the upper leaf 12 is illustrated. On the other hand, the distance between the swivel axis 32 and the inner surface of its own leaf, i.e. in this case the lower leaf 14, is illustrated. Deducting the distance T from the distance A now will result in a value F, which should be smaller than the thickness of the finger of a user. This distance F is illustrated in FIG. 2 proceeding from the edge 44 and clearly shows that as a result the gap between the two leaves 12 and 14 is so small that pinching the finger here is not possible, even if during its movement the leaf 14 is in the position orthogonal to the leaf 12, which is illustrated in dash-dotted lines.

In the different positions of the leaves 12 and 14 of the folding door 16, FIGS. 4 and 5 clearly show that as a result of the articulation of the hinge arm 30 at the swivel axis 32 of the hinge pot 14, the distances are chosen such that there is no risk of pinching a finger.

With reference to the simplified FIG. 1, a parallelogram is illustrated by broken lines, which is formed by the link system consisting of the swivel axes 24, 32, 38 and 40. Although there is not obtained an exact parallelogram, the arrangement of the imaginary legs, which here are illustrated in broken lines, approximately represents a parallelogram. This similarity with the parallelogram is such that the movement of the lower leaf 14 from the closing position to the lower intermediate position as shown in FIG. 5 is effected approximately parallel to itself, and in the closed position of the folding door, the two leaves 12 and 14 are not substantially folded towards the body at the point where they are connected with each other, although the user opens the folding door via the bottom edge of the lower leaf.

Advantageously, the imaginary leg 52 between the swivel axis 40 and the swivel axis 24 is about 20% longer than the imaginary leg 54 between the swivel axis 38 and the swivel axis 32. In addition, the imaginary leg 56 between the swivel axes 32 and 24 is about 15% longer than the imaginary leg 50 between the swivel axis 38 and the swivel axis 40. This effects that after a first approximately parallel movement in the opening direction, the lower leaf 14 can reach the upper position as shown in FIG. 5. In accordance with the invention, the link system can, however, also be approximated much more to a parallelogram, because then the lower leaf nevertheless would remain approximately parallel to itself during its movement. The arrangement of the parallelogram now depends on how the accessibility of the interior of the body should be achieved.

FIG. 3 now shows a particular aspect of the invention, in which in the vicinity of its pivot point 38 the lever 34 of the lifting device abuts against the fitting 36 of the lower partial flap by means of an eccentrically arranged friction device 60 already known per se, which cooperates with the lever 34 of the lifting device 18 such that it adjusts the swivelling speed of the folding door or approximately achieves the maintenance of a certain desired intermediate position by applying a frictional force.

FIG. 6a or b, 7a or b, 8a or b, 9a or b, 10a or b and 11a or b show various embodiments of hinges which connect the upper leaf 12 and the lower leaf 14 of a folding door 16 with each other. The respective leaves 12 and 14 can be made of different materials. Here, wood can be used as a material for the leaves 12 and 14. As another material, an extruded profile, a chipboard or glass can be used. In all embodiments, the leaves swivel about the axis 32, which is each formed by a pin which is disposed in a hinge pot inserted in the lower leaf.

In the embodiment as shown in FIG. 6, the hinge 26 corresponds to the hinge already shown in FIG. 2. Here, the hinge arm 30 is formed in the usual way, as this is known already for four-link hinges. Accordingly, the hinge arm 30 is adjustable in three coordinate directions via a mounting plate. The hinge arm 30 is adjoined by an extension arm 31 which is fixed by the usual pins for the links. The flange of the hinge pot faces away from the edge of the door leaf, so that the arm 31 is held in the narrower part of the hinge pot. The dimension of the extension arm 31 is chosen such that the same can be pivotally mounted in the vicinity of the wrist pin 32 even in the case of a hinge pot 28′ for attachment on an extruded profile, as can be taken from the embodiment shown in FIG. 7. In this embodiment, the hinge pot 28′ is made comparatively smaller.

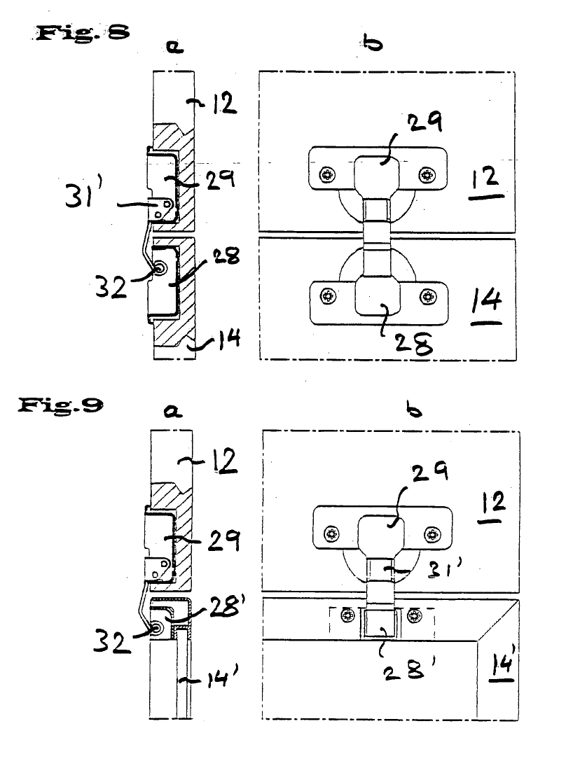

In the embodiment as shown in FIG. 8, the arm 31′ is connected by means of pins not with a hinge arm 30 (as in FIGS. 6 and 7), but with a hinge pot 29, so that the two door leaves 12, 14 are pivotally connected with each other in a very compact and space-saving form.

As shown in FIG. 9, the leaf 12 similarly is connected with the lower leaf 14′, which consists of an extruded profile and for which the same hinge pot 28′ is provided.

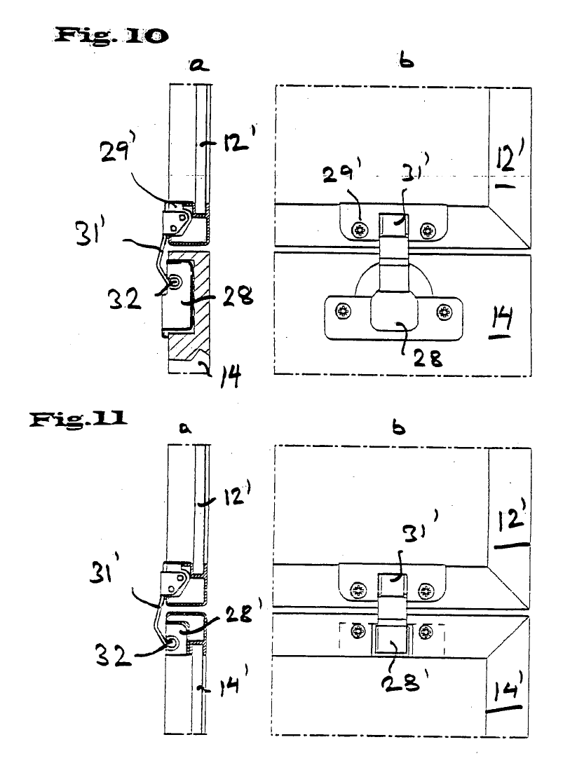

In the embodiments as shown in FIGS. 10 and 11, the upper door leaf 12′ is formed of an extruded profile, and the same arm 31′ here is attached to a suitable hinge part 29′. The lower door leaves 14, 14′ here correspond to the door leaves in accordance with the previous embodiments.

In all embodiments, the fastening means of the various hinge parts are dimensioned and arranged such that the same and the various furniture parts 12, 12′, 14, 14′ are replaceable without influencing the lifting device, so that their advantages remain unchanged.

1. A lifting device for a two-leaf folding door, whose upper leaf is pivotally mounted about a horizontal first axis on a top or intermediate wall of a body, and whose lower leaf is pivotally connected with the upper leaf about a second axis parallel to the first axis, comprising
at least one double-armed lever which is pivotally mounted about a horizontal swivel axis on a lateral body part and whose longer arm is pivotally connected with the lower leaf,
a hinge for pivotally connecting the two leaves, which is provided with a hinge pot to be inserted in one of the leaves,
a hinge arm to be fixed at the other leaf, and
a swivel axis which is arranged in the hinge pot such that its distance (A) from the nearest edge of the other leaf reduced by the distance (T) from the inner surface of its own leaf has a value (F) which is smaller than the thickness of the finger of a user, and
in the closed condition of the folding door, the swivel axes of the lever of the lifting device are arranged such that together with the swivel axis between the two leaves and the swivel axis of a hinge connecting the upper leaf with the upper body wall, the same form a four-link system, whose opposite legs extend approximately parallel to each other and whose lengths do not differ from each other by more than 20%.

2. The lifting device as claimed in claim 1, wherein the hinge pot is inserted in the lower leaf.

3. The lifting device as claimed in claim 1, wherein the hinge arm is selectively adjustable in the three coordinate directions.

4. The lifting device as claimed in claim 1, wherein the leg of the four-link system between the swivel axis of the hinge connecting the upper leaf with the upper furniture wall and the upper swivel axis of the lever is 20% longer than the leg between the swivel axis between the two leaves and the lower swivel axis of the lever.

5. The lifting device as claimed in claim 1, wherein the leg of the four-link system between the upper swivel axis of the lever and the lower swivel axis is 15% shorter than the leg between the swivel axis between the two leaves and the swivel axis of the hinge connecting the upper leaf with the upper furniture wall.

6. The lifting device as claimed in claim 1, wherein in the vicinity of its articulation at the lower leaf, the lever is acted upon by an eccentric friction device such that the swivelling speed of the door is changed or the lifting device can take any intermediate position.

7. The lifting device as claim 1, wherein one end of a compression spring element is pivotally connected with the body part and the other end is pivotally connected with the two-armed lever.

8. The lifting device as claimed in claim 7, wherein the spring element is a gas spring.

9. The lifting device as claimed in claim 1, wherein the leaves of the folding door are connected with each other via at least one hinge which has a hinge arm whose end portion carrying the swivel axis is dimensioned such that the same can be pivotally mounted in a usual hinge pot for a leaf made of wood and alternatively in a more closely dimensioned hinge pot, as it is employed when using a leaf made of an extruded profile.

10. The lifting device as claimed in claim 9, wherein the leaves of the folding door are connected with each other via at least one hinge, which has an extension arm whose dimension is chosen such that the same is insertable in a usual hinge pot for a leaf made of wood and alternatively in a more closely dimensioned hinge pot, as it is employed for instance when using a leaf made of an extruded profile.

11. The lifting device as claimed in claim 2, wherein the hinge arm is selectively adjustable in the three coordinate directions.

12. The lifting device as claimed in claim 11, wherein the leg of the four-link system between the swivel axis of the hinge connecting the upper leaf with the upper furniture wall and the upper swivel axis of the lever is 20% longer than the leg between the swivel axis between the two leaves and the lower swivel axis of the lever.

13. The lifting device as claimed in claim 2, wherein the leg of the four-link system between the swivel axis of the hinge connecting the upper leaf with the upper furniture wall and the upper swivel axis of the lever is 20% longer than the leg between the swivel axis between the two leaves and the lower swivel axis of the lever.

14. The lifting device as claimed in claim 3, wherein the leg of the four-link system between the swivel axis of the hinge connecting the upper leaf with the upper furniture wall and the upper swivel axis of the lever is 20% longer than the leg between the swivel axis between the two leaves and the lower swivel axis of the lever.

15. The lifting device as claimed in claim 14, wherein the leg of the four-link system between the upper swivel axis of the lever and the lower swivel axis is 15% shorter than the leg between the swivel axis between the two leaves and the swivel axis of the hinge connecting the upper leaf with the upper furniture wall.

16. The lifting device as claimed in claim 2, wherein the leg of the four-link system between the upper swivel axis of the lever and the lower swivel axis is 15% shorter than the leg between the swivel axis between the two leaves and the swivel axis of the hinge connecting the upper leaf with the upper furniture wall.

17. The lifting device as claimed in claim 3, wherein the leg of the four-link system between the upper swivel axis of the lever and the lower swivel axis is 15% shorter than the leg between the swivel axis between the two leaves and the swivel axis of the hinge connecting the upper leaf with the upper furniture wall.

18. The lifting device as claimed in claim 4, wherein the leg of the four-link system between the upper swivel axis of the lever and the lower swivel axis is 15% shorter than the leg between the swivel axis between the two leaves and the swivel axis of the hinge connecting the upper leaf with the upper furniture wall.

19. The lifting device as claimed in claim 13, wherein the leg of the four-link system between the upper swivel axis of the lever and the lower swivel axis is 15% shorter than the leg between the swivel axis between the two leaves and the swivel axis of the hinge connecting the upper leaf with the upper furniture wall.

20. The lifting device as claimed in claim 12, wherein the leg of the four-link system between the upper swivel axis of the lever and the lower swivel axis is 15% shorter than the leg between the swivel axis between the two leaves and the swivel axis of the hinge connecting the upper leaf with the upper furniture wall.
